(19) United States
(12) Patent Application Publication
(10) Pub. No.: US 2023/0311415 A1
(43) Pub. Date: Oct. 5, 2023

(54) METHOD AND APPARATUS FOR PRODUCING THREE-DIMENSIONAL OBJECTS BY SELECTIVELY SOLIDIFYING A BUILD MATERIAL APPLIED LAYER BY LAYER

(71) Applicant: TRUMPF Laser- und Systemtechnik GmbH, Ditzingen (DE)

(72) Inventors: Florian Schaede, Stuttgart (DE); Kai Etzel, Besigheim (DE); Christian Dueformantel, Esslingen (DE); Lukas Witz, Schramberg (DE); Joachim Wagner, Stuttgart (DE); Armin Burkhardt, Oberreichenbach (DE)

(21) Appl. No.: 18/311,256

(22) Filed: May 3, 2023

Related U.S. Application Data
(63) Continuation of application No. PCT/EP2021/080817, filed on Nov. 5, 2021.

(30) Foreign Application Priority Data
Nov. 9, 2020 (DE) 10 2020 129 419.0

(51) Int. Cl. B29C 64/268; B29C 64/364; B29C 64/245; B29C 64/209

(52) U.S. Cl. CPC B29C 64/268; B29C 64/364; B29C 64/245; B29C 64/209; B33Y 10/00

(57) ABSTRACT

A method for producing a three-dimensional object by selectively solidifying a build material applied layer by layer includes, in at least one process chamber, applying the build material layer by layer to a build platform, generating at least one beam for solidifying the build material using a radiation source, feeding the at least one beam to the build material in the build platform using at least one beam guiding element, and generating a primary gas flow along the build platform using a process assistance device. The process assistance device includes a centre module and at least one outer module aligned with the centre module, so that a section over which primary gas flows is formed between the centre module and the at least one outer module. The centre module and/or the at least one outer module are triggered so as to be movable along the build platform.

### CROSS REFERENCE TO RELATED APPLICATIONS

This application is a continuation of International Application No. PCT/EP2021/080817 (WO 2022/096668 A1), filed on Nov. 5, 2021, and claims benefit to German Patent Application No. DE 10 2020 129 419.0, filed on Nov. 9, 2020. The aforementioned applications are hereby incorporated by reference herein.

### FIELD

Embodiments of the present invention relate to a method and to an apparatus for producing three-dimensional objects by selectively solidifying a build material applied layer by layer.

### BACKGROUND

DE 10 2017 211 657 A1 discloses an apparatus for additive manufacturing of a component with protective gas guiding means, and a method in this respect. This apparatus comprises a process assistance device having a centre module and a respective outer module aligned with the centre module. The centre module is triggered so as to be able to move above a build platform. The centre module comprises a coater, via which build material is fed from a powder reservoir, with the result that said build material is discharged onto the build platform during the movement of the centre module. A respective gas outlet device, the protective gas outlets of which are aligned towards the outer module, is provided on either side of the coater. During the solidification of the build material, a protective gas is discharged through a multiplicity of protective gas outlets and extracted by suction by the opposite outer module. This outer module in the form of a suction extracting device can be triggered so as to be able to move synchronously with the centre module, while the build material is being solidified by means of a laser beam in the region in between.

WO 2019/115140 A1 furthermore discloses a method and an apparatus for producing three-dimensional objects by selectively solidifying a build material applied layer by layer. This apparatus comprises a receiving device, to which a centre module and, adjacent to each outer end, a respective outer module are fastened in stationary fashion. The centre module comprises a coater and a respective suction extracting device, which is aligned with the outer module. While the laser beam is being fed to a build platform between an outer module and the centre module, a process gas stream from the outer module to the suction extracting device on the centre module is generated. The opposite outer module is cut off from the feed of a process gas stream.

EP 1 137 504 B 1 discloses a method and an apparatus for selective laser melting of build material to produce a three-dimensional object. A process gas stream containing argon, which is aligned horizontally and extracted by suction from an intake opening on one side of the process chamber to an outlet opening on the opposite, or left-hand, wall of the process chamber, is generated above a build platform. Feed openings for a helium process gas stream are provided above the build platform and close to a passage window for the laser beam. In a similar way to the process gas stream guided parallel to the build platform, this helium process gas stream is extracted by suction through the one outlet opening in the left-hand wall of the process chamber. The two process gas streams fed into the process chamber are extracted by suction through an outlet opening provided on the process chamber.

EP 3 147 047 A1 furthermore discloses a method and an apparatus for producing three-dimensional objects by selectively solidifying a build material applied layer by layer. In the case of this apparatus, it is provided that, by way of a shared gas supply source, a first process gas stream is fed through a right-hand wall of the process chamber, guided along above the build platform, and removed through an outlet opening on the left-hand process chamber wall. The process gas supply source feeds a second process gas stream from a flow head which is arranged above the build platform and has a multiplicity of outlet openings, through which the second gas stream is fed towards the build platform. This process gas stream introduced into the process chamber through the flow head, together with the first process gas stream, is extracted by suction through the shared opening on the left-hand wall of the process chamber.

### SUMMARY

Embodiments of the present invention provide a method for producing a three-dimensional object by selectively solidifying a build material applied layer by layer. The method includes, in at least one process chamber, applying the build material layer by layer to a build platform, generating at least one beam for solidifying the build material using a radiation source, feeding the at least one beam to the build material in the build platform using at least one beam guiding element, and generating a primary gas flow along the build platform using a process assistance device. The process assistance device includes a centre module and at least one outer module aligned with the centre module, so that a section over which primary gas flows is formed between the centre module and the at least one outer module. The centre module and/or the at least one outer module are triggered so as to be movable along the build platform.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic side view of an apparatus for producing three-dimensional objects by selectively solidifying a build material applied layer by layer according to some embodiments;

FIG. 2 shows a perspective sectional view of a process chamber according to FIG. 1;

FIG. 3 shows a perspective view of a feed device for a secondary gas stream according to some embodiments;

FIG. 4 shows a secondary view, from below, of the feed device for the secondary gas stream according to some embodiments;

FIG. 5 shows a schematic side view of the process chamber with a primary gas stream and a secondary gas stream according to some embodiments;

FIG. 6 shows a perspective view of a sudden-expansion diffusor for feeding a primary gas or secondary gas according to some embodiments;

FIG. 7 shows a schematic side view of a process chamber according to an alternative embodiment to FIG. 5 while the build material is being solidified by a beam;

FIG. 8 shows a schematic side view of the process chamber in a further working step in relation to FIG. 7 for producing a three-dimensional object according to some embodiments; and

FIG. 9 shows a perspective sectional view of an alternative embodiment of an outer module in relation to FIG. 7.

### DETAILED DESCRIPTION

Embodiments of the present invention provide a method and an apparatus for producing three-dimensional objects by selectively solidifying a build material applied layer by layer, by virtue of which the quality of the three-dimensional object and the process reliability are increased.

According to some embodiments, a method for producing three-dimensional objects by selectively solidifying a build material applied layer by layer, in the course of which method the centre module and/or the at least one outer module are triggered so as to be movable along the build platform. This embodiment enables individual adaptation to the three-dimensional object that is to be built up in the build platform. Furthermore, an optimized process gas flow along the build platform and/or in the process chamber can be enabled. For example, a primary gas flow can be generated along the build platform, with the result that a section over which primary gas flows is formed between a centre module and at least one outer module. In addition to this primary gas flow, a feed device above the build platform can introduce a secondary gas flow into the process chamber and align it onto the build platform, and a section along which the secondary gas flows can be created between the feed device and the process assistance apparatus. This has the advantage of inducing continuous flushing of the process chamber with the secondary flow, with the result that laser-particle interaction is considerably reduced. This enables uniform process conditions, and therefore, by virtue of the combination of the primary gas stream and the secondary gas stream, an improved quality in the build of three-dimensional objects and an increase in process reliability are achieved.

According to a preferred embodiment of the method, it can be provided that the two outer modules are triggered to be at a standstill, or fixedly arranged, in a respective end position outside the build platform and the centre module is triggered to move over the build platform. This enables easier triggering of the process assistance device, in that only a movement of the centre module is triggered.

As an alternative, it may be provided that the centre module and the at least one outer module are triggered to move along the build platform, wherein the distance between the centre module and the at least one outer module is triggered to be constant or variable. As a result of this alternative embodiment, it can be made possible to form, between the centre module and the respective outer module, short paths over which flow occurs and within which the process gas has a homogeneous flow profile.

Advantageously, each outer module discharges a primary gas stream towards the centre module, wherein the fed primary gas stream is extracted by suction by a suction extracting device, which is aligned with each outer module and provided on the centre module. This makes it possible to enable consistent conditions during the solidification of the build material.

Preferably, it is provided that a primary gas stream is discharged by at least one outer module and a secondary gas stream is discharged by a feed device, and in that the primary gas stream and the secondary gas stream are extracted by suction together by the centre module of the process assistance device. This triggering of the centre module to extract the primary gas stream and the secondary gas stream by suction makes it possible to selectively enable solidification of the build material by the beam on either side of the centre module, wherein the centre module is moved correspondingly in relation to the build platform. In addition, improved flushing of the entire process chamber can be enabled in order to guide dirt out of the process chamber.

During a movement of the centre module above the build platform, it is preferably provided that the two suction extracting devices of the centre module are triggered to extract the primary gas jet and the secondary gas jet by suction. This enables complete extraction of the gases from the process chamber by suction.

In the event of a movement of the centre module into or out of an end position adjacent to the build platform or in the event of a positioning of the centre module in the end position, preferably a constant flow of the primary jet and secondary jet is triggered. This makes it possible to optimize the process time. As an alternative, it may be provided that only that suction extracting device of the centre module that faces the build platform is triggered to extract the primary and secondary jet by suction. In particular when assuming an end position, the centre module can be filled, for example, with build material and the primary gas jet and secondary gas jet can nevertheless be extracted by suction, that is to say that, while a storage container is being filled with build material in the centre module, the build material can continue to be solidified.

Furthermore, it is preferably provided that, in the event of a movement of the centre module into or out of an end position adjacent to the build platform or in the event of a positioning of the centre module in the end position, only that outer module that is opposite and remote from the centre module is triggered to discharge the primary gas stream. This makes it possible to avoid disruptive turbulences, in particular resulting from the delivery of removed build material to overflow containers arranged adjacent to the build platform.

Furthermore, it is preferably provided that a magnitude of an exposure zone between the centre module and the respective outer module is controlled by the movement of the centre module and/or of the outer module. This makes it possible to achieve optimum extraction by suction depending on the size of the three-dimensional object that is to be produced.

Embodiments of the present invention provide an apparatus for producing three-dimensional objects by selectively solidifying a build material applied layer by layer, which apparatus has a process assistance apparatus with a centre module and a respective outer module aligned with it, wherein the centre module and/or the at least one outer module can be triggered so as to be movable along the build platform. This enables high flexibility and process optimization in the course of the production of three-dimensional objects.

According to a preferred embodiment of the apparatus, it is provided that the two outer modules are arranged at a standstill in relation to the process chamber, or fixedly in relation to the process chamber, and the centre module is movable along the build platform. This makes it possible to simplify the structure of the process chamber on account of the outer modules, which are stationary.

As an alternative, it may be provided that the centre module and the at least one outer module can be triggered to move along the build platform, and preferably the distance between the centre module and the at least one outer module can be triggered to stay the same or be variable. The centre module and the at least one outer module or the two outer modules can be directly and individually triggered to move. In this case, the outer modules may be formed with feed channels, the length of which is variable and which in particular are telescopic. This enables increased flexibility in the course of the production of three-dimensional objects in terms of the formation of process gas flows.

Preferably, it is provided that the centre module has a suction extracting device, which faces the respective outer module and extends at least over the width of the build platform, that is to say in the Y direction. This suction extracting device is preferably in the form of a rotary tube with a continuous suction-extraction opening. This makes it possible for the centre module to enable extraction of the primary gas stream and/or of the secondary gas stream by suction on either side.

Preferably layer-shaped storage containers for the build material and a coating device between them are arranged between the two suction extracting devices of the centre module of the process assistance device. As a result, a compact arrangement and structure for the centre module can be provided, with the result that at the same time discharging and coating of the discharged build material for the next layer to be solidified is made possible.

Advantageously, each outer module has an outlet nozzle, which is provided on a feed channel for the process gas. The outlet nozzle on the outer module preferably has a polynomial nozzle shape. As a result, the primary gas stream flowing out of the outlet nozzle is accelerated and stabilized, resulting in homogeneity of the process gas flow along the path over which flow passes. Advantageously, the feed channel has a variable length, in particular is telescopic. This makes it possible for the outlet nozzle to be moved above the build platform depending on the position of the centre module.

It is preferably provided that a section over which primary gas flows is formed between the centre module and the at least one outer module to generate a primary gas flow and a feed device for a secondary gas flow is provided above the build platform, wherein the secondary gas flow is aligned onto the build platform from above by the feed device, and a section along which flow occurs is formed between the feed device and the process assistance device. This makes it possible to build up a targeted flow of a primary gas flow and a secondary gas flow through the process chamber, in order to keep the process gas chamber free of dirt, byproducts or the like. In addition, by introducing the secondary gas flow above the build platform, it is possible to efficiently flush the process chamber, as a result of which laser-particle interaction or lengthy dwell times of particles in the process chamber are avoided.

According to a preferred embodiment of the outer module, provision is made of a movable outlet nozzle which is aligned transversely in relation to the movement direction along the build platform and extends between process chamber side walls that laterally delimit the process chamber. This outlet nozzle preferably has an adjacent and extensible cover which is arranged above the build platform and in particular extends in the width between the process chamber side walls that laterally delimit the process chamber. This makes it possible to provide a straightforward and cost-effective configuration for a feed of a process gas flow into the process chamber.

Preferably, the feed channel for the primary gas intended to flow out of the outlet opening is formed at least by the extensible cover and the process chamber side walls. Furthermore, it can be provided that the extensible cover has side wall portions which laterally adjoin it and extend as far as the process chamber floor. This makes it possible to form a downwardly open feed channel. This has the advantage that flow occurring underneath the outlet nozzle is avoided and at the same time a feed of protective gas close to the powder is enabled. In addition, it is possible to generate considerably less turbulence than, for example, in the case of telescopic feed channels. Reapplication of the flow and buildup of a boundary layer over a determined path of travel can be dispensed with in this case.

Furthermore, it is preferably provided that the centre module and the at least one outer module are connected fixedly to one another by at least one coupling element. This makes it possible to utilize the triggering of a movement by the centre module to forcibly carry along the at least one outer module coupled to the centre module. This facilitates the triggering of the centre module and the at least one outer module.

The coupling element can be provided as movable along the process chamber side wall. Preferably, the coupling element is guided in an outlet opening in the process chamber side wall, through which outlet opening the processed process gas can be discharged from the process chamber. Consequently, the coupling element makes it possible both to form a laterally movable curtain or a closure element for the outlet opening in the process chamber side wall and to achieve a compulsory movement of the at least one outer module together with the centre module.

Preferably, the coupling element is guided with a gap cover in the outlet opening in the process chamber side wall. This makes it possible to avoid flows in the gap.

The outlet nozzle preferably has flow lamellae, in particular horizontally aligned flow lamellae, which form subchannels in the outlet opening of the outlet nozzle for a targeted flow. Preferably, these flow lamellae have an S-shaped form as viewed in the outflow direction of the primary gas. This makes it possible to achieve an improved and turbulence-free feed of the process gas in this region of the subchannels.

Furthermore, it can be provided that, in the outlet opening, the outlet nozzle has at least one subchannel which is closed by a filter laminate for forming a diffuse flow. This filter laminate is permeable to the primary gas stream. As a result, a primary gas stream can be fed with a lower flow velocity than it has through the further subchannels of the process chamber.

In particular, it is provided that the outlet nozzle, in a top region, comprises at least one subchannel closed by the filter laminate and, in the bottom region, has multiple open subchannels which are formed by the flow lamellae, wherein the flow lamellae are aligned in such a way that the flow velocity increases from top to bottom and towards the build platform. This makes it possible to obtain an increased flow velocity directly above the build platform, as a result of which effective extraction of the processed primary gas by suction is enabled. Furthermore, this arrangement has the advantage that the flow velocity in the top region in which the filter laminate is provided can be adapted to a secondary gas flow fed into the process chamber from above, with the result that a shear effect and turbulent interactions between the primary gas stream and the secondary gas stream can be reduced. In addition, the outflow over the entire cross section of the primary channel makes it possible to avoid eddy formation and recirculation.

In addition, such an arrangement makes it possible for the targeted flow discharged through the lamellae that have an S-shaped form to be able to be stabilized.

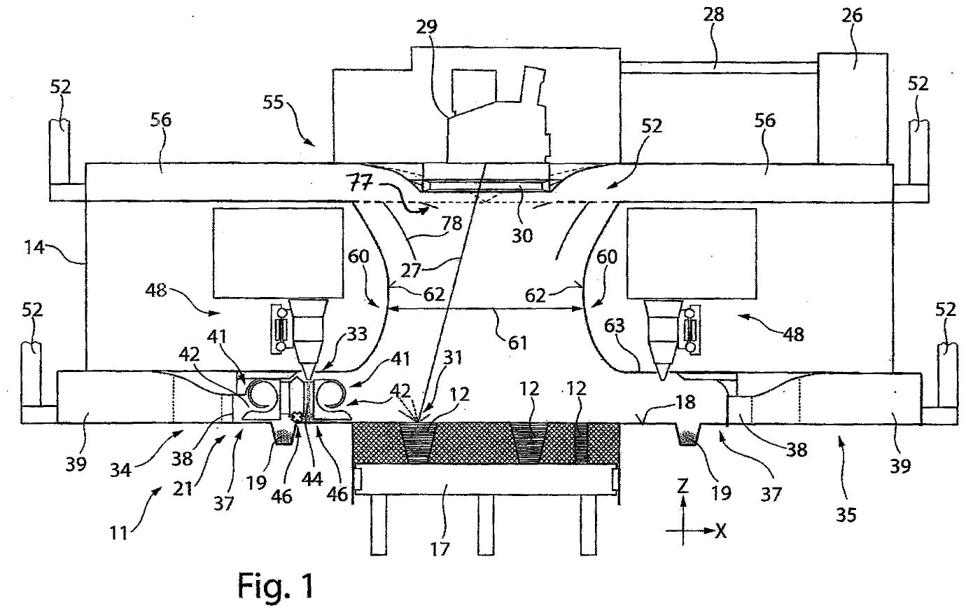

FIG. 1 illustrates a schematic side view of an apparatus 11 for producing three-dimensional objects 12 by selectively solidifying a build material applied layer by layer. These apparatuses 11 are also referred to as 3D printing systems, selective laser sintering machines, selective laser melting machines, or the like. The apparatus 11 comprises a housing 14, in which a process chamber 16 is provided. The process chamber 16 is closed towards the outside. It can be accessible via a door, which is not illustrated in more detail, or a safety closure. A build platform 17, on which at least one three-dimensional object 12 is created layer by layer, is provided in the process chamber 16. The size of the build platform 17 determines a construction field for the production of the three-dimensional objects 12. The build platform 17 can be moved vertically, or in the Z direction. Provided adjacent to the build platform 17 are overflow containers 19 or collection containers, in which non-required or non-solidified build material is gathered. A process assistance device 21 is arranged in the process chamber 16 above the build platform 17. This process assistance device 21 is triggered so as to be able to move at least partially in the X direction.

A radiation source 26, which generates a beam 27, in particular a laser beam, is assigned to the process chamber 16 or secured to the process chamber 16. This laser beam is guided along a beam guide 28 and is deflected and directed onto the build platform 17 by a triggerable beam guiding element 29. In the process, the beam 27 enters the process chamber 16 through a beam inlet opening 30. The build material applied to the build platform 17 can be solidified at the impingement point 31 of the beam 27.

The process assistance device 21 comprises a centre module 33 and a respective outer module 34, 35 assigned to the centre module 33. In the embodiment of the process assistance device 21 according to FIG. 1, it is provided that the outer modules 34, 35 are stationary in relation to a process chamber floor 18. The centre module 33 is triggered so as to be movable between a left and right end position 34, 35. In the view according to FIG. 1, the centre module 33 is positioned in the left end position 36. The outer modules 34 comprise an outlet nozzle 38, which is secured to a feed channel 39. This outlet nozzle 38 preferably has vertically aligned guide surfaces. In addition, the outlet nozzle 38 tapers in the direction of emergence. This makes it possible to homogenize and stabilize a primary gas stream fed into the process chamber 16.

The centre module 33 comprises two suction extracting devices 41, which have a respective oppositely aligned intake opening 42. A storage container 44 for receiving build material is provided between the suction extracting devices 41. This storage container 44 has at least one opening or a discharge slot pointing towards the process chamber floor 18, with the result that a layer of build material can be discharged by the centre module 33 when it is moving over the build platform 17. A coating device 46 is preferably provided between two storage containers 44 that are arranged adjacent to the suction extracting device 41. Preferably, the storage container 44 which is at the front in the direction of movement of the centre module 33 is filled with build material. The coating device 46 comes next. In particular, the coating device 46 comprises at least one coater lip.

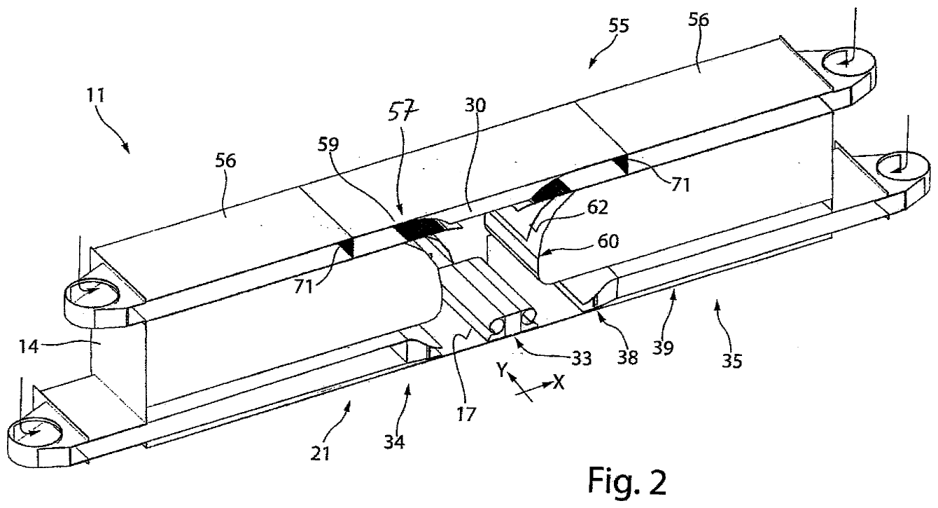

The centre module 33 is preferably filled with build material in the right and/or left end position 36, 37. In this respect, a metering apparatus 48 can be assigned to the one end position or both end positions 36, 37. This metering apparatus 48 can be moved along a Y axis (FIG. 2), with the result that the storage container 44 can be uniformly filled over the width of the centre module 33.

The overflow container 19 is likewise assigned to the right and the left end position 36, 37, with the result that stripped build material can be removed into the overflow container 19 by the coating device 46 of the centre module 33 when the end position 36, 37 is assumed.

Each outer module 33 is connected to a supply line 52. This supply line 52 is exposed to a primary gas by a pump or primary gas source, which is not illustrated in more detail, with the result that a primary gas flow can be discharged into the process chamber 16 by the outer modules 34.

A feed device 55 for a secondary gas flow into the process chamber 16 is provided above the process chamber 16. This feed device 55 comprises two mutually opposite feed channels 56, which are positioned adjoining the beam inlet opening 30. The secondary gas flows into the process chamber 16 and is fed from above onto the build platform 17 through at least one feed opening 57, which is assigned to or surrounds the beam inlet opening 30.

The process chamber 16 has lateral wall portions 60, which delimit the length of the process chamber 16. These wall portions 60 comprise flow surfaces 62, which extend towards the build platform 17 and constrict a cross-sectional area of the process chamber 16. This provides a distance 61 which corresponds to, or preferably is smaller than, the length of the build platform 17 that extends in the X direction, as illustrated in FIG. 1. The flow surface 62 widens from the smallest distance 61. The wall portion 60 merges into a horizontal boundary surface 63. This boundary surface 63 preferably runs parallel to the process chamber floor 18 and is provided at a distance from the process chamber floor 18, such that the process assistance device 21 can be positioned between the boundary surface 63 and the process chamber floor 18. This configuration of the process chamber 16 results in a tulip-shaped cross section or a tulip-shaped contour, as a result of which flow optimization when a secondary gas is being fed into the process chamber 16 from above is enabled. As an alternative, the process chamber 16 can have a conical contour or the contour of a parabolic inlet funnel.

Secondary gas is supplied to each feed channel 56 of the feed device 55 by way of a secondary gas source, not illustrated in more detail, through a supply line 52.

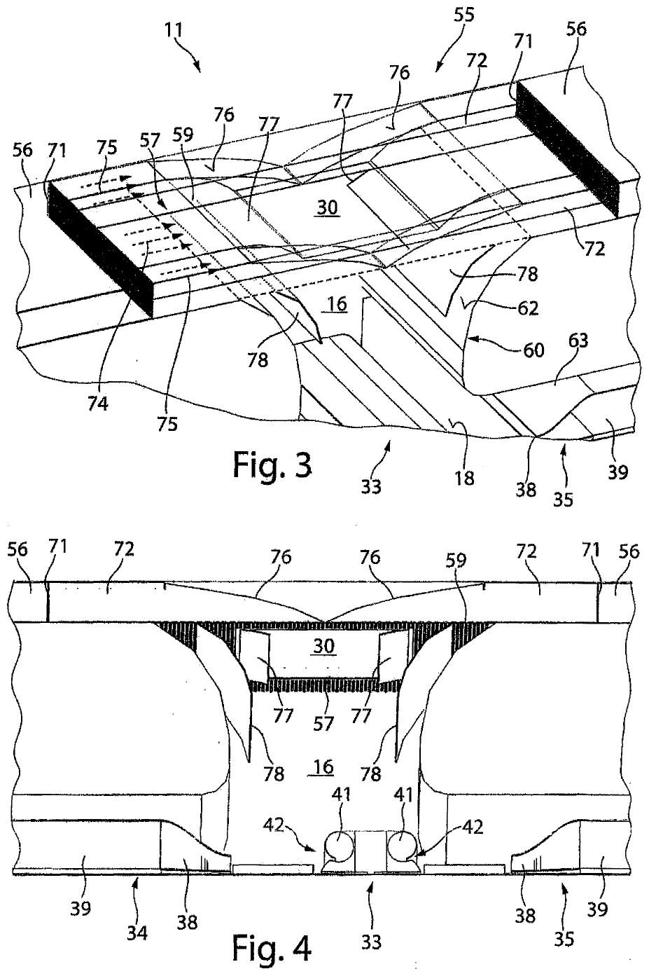

With reference to the following FIGS. 2 to 4, the feed device 55 for feeding a secondary gas and for forming a secondary gas stream inside the process chamber 16 will be described in more detail.

A perforated plate 71 extending over the cross section is preferably provided in the feed channel 56. As a result, it is already possible to achieve a first homogeneous division of the stream of the fed secondary gas. The feed channel 56 leads into the feed opening 57. In the exemplary embodiment, the feed opening 57 is formed by a throughflow element 59, such as a flow screen. This throughflow element 59 can, for example, also be in the form of a perforated plate or a gas-permeable knitted fabric or a multi-layer metal woven fabric or the like. The feed opening 57 completely surrounds the beam inlet opening 30. Thus, the feed opening 57 and the beam inlet opening 30 are in a common plane.

Baffles 72, which subdivide the cross section of the feed channel 55 into a core stream 74 and two external lateral streams 75, extend between the perforated plate 71 in the feed channel 55 and the feed opening 57. These baffles 72 extend along the width of the beam inlet opening 30, each over half of the length of the beam inlet opening 30. At the same time, the feed channel 56 has an upper curved surface 76, in order to feed the lateral streams 75 to the process chamber 16 via the lateral regions of the feed opening 57.

A reverse-stream fin 77 is assigned to each end face of the beam inlet opening 30 at the feed opening 57. This reverse-stream fin 77 is provided at a distance from the beam inlet opening 30 inside the process chamber 16. These reverse-stream fins 77 are aligned virtually horizontally. As a result, a horizontal reverse stream is fed through the feed channels 56 from either side, these horizontal reverse streams meeting in the middle of the beam inlet opening 30 and then creating a secondary gas stream directed downstream. A respective flow stabilizer 78 is provided between an end face of the beam inlet opening 30 and the wall portion 60. Said flow stabilizer preferably has a curvature corresponding to the flow surface 62. This flow stabilizer 78 extends over the entire width of the feed channel 56 or feed opening 57. These flow stabilizers 78 enable a reverse-stream-free and/or directed secondary gas stream in the peripheral region of the process chamber 16 irrespective of the position of the centre module 33.

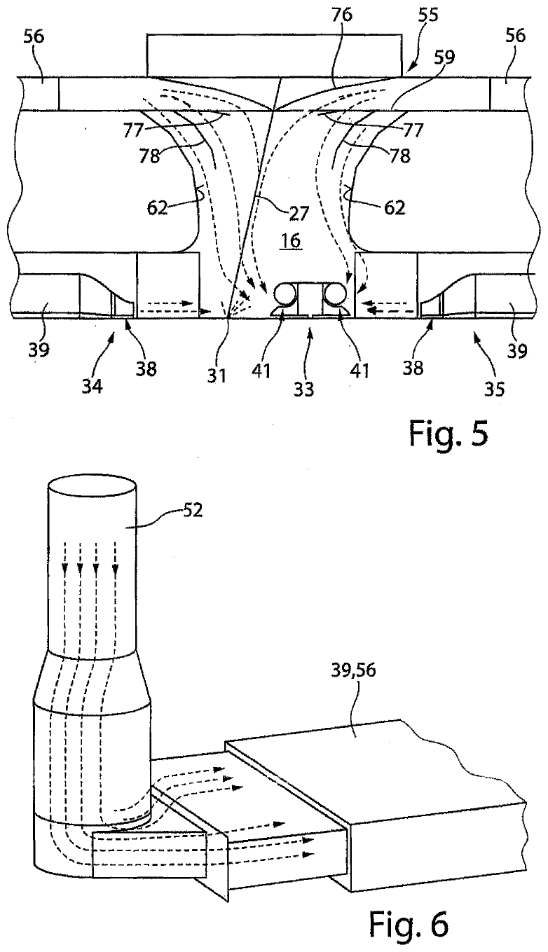

FIG. 5 illustrates a schematic side view of the process chamber 16 according to FIG. 1 during a working step for producing a three-dimensional object 12. The beam 27 is directed at the build material in the build platform 17 and solidifies the build material at the impingement point 31. The centre module 33 is, for example, positioned adjacent to the impingement point 71 on the right. This centre module 33 can follow the beam 27, which is advanced for example towards the left end position 36. At the same time, the process assistance device 21 is exposed to a primary gas and the feed device 55 is exposed to a secondary gas. In the process, according to a first embodiment, it is provided that a primary gas stream is generated between a left outer module 34 and the centre module 33 and a secondary gas stream is generated between the feed device 55 and the centre module 33. In this first embodiment, only the left suction extracting device 41 of the centre module 33 is triggered for shared extraction of the primary gas stream and the secondary gas stream by suction. As an alternative, it may be provided that a primary gas stream is discharged by the left and right outer module 34, 35, which primary gas stream is extracted by suction by the respective left and right suction extracting device 41 of the centre module 33. In addition, at the same time a secondary gas stream is fed to the centre module 33 by the feed device 55. Owing to the position, illustrated in FIG. 5, of the centre module 33, an enlarged volume flow of the secondary gas is fed to the left suction extracting device 41 and extracted by suction together with the primary gas stream. A smaller volume flow of the secondary gas flow can be extracted by suction together with the right primary gas stream by the right suction extracting device 41 of the centre module 33. In this embodiment, both suction extracting devices 41 of the centre module 33 perform shared extraction by suction of the primary gas stream and secondary gas stream fed to the process chamber 16.

Preferably, it is provided that the outlet nozzle 38 of the outer modules 34, 35 has an opening cross section which is more than 1.5 times larger, in particular more than 3 times larger, than the intake openings 42 of the suction extracting device 41.

FIG. 6 illustrates a perspective view of a sudden-expansion diffuser 81. This sudden-expansion diffuser 81 is formed between the supply line 52 and the feed channel 39 or 56. In this respect, it is provided that the fed process gas is deflected, for example by 90°, and at the same time undergoes retardation of the flow owing to the enlargement of the cross section from the supply line 52 to the feed channel 39, 56. The deflection can also be effected at an angle of greater or less than 90°. This retardation is preferably effected in accordance with the Prandtl sudden-expansion diffuser principle, by having the flow, which is preferably pre-retarded, impact the baseplate of the sudden-expansion diffuser. This makes it possible to achieve a flaring of the fed process gas jet into two core streams in the feed channel 39, 56.

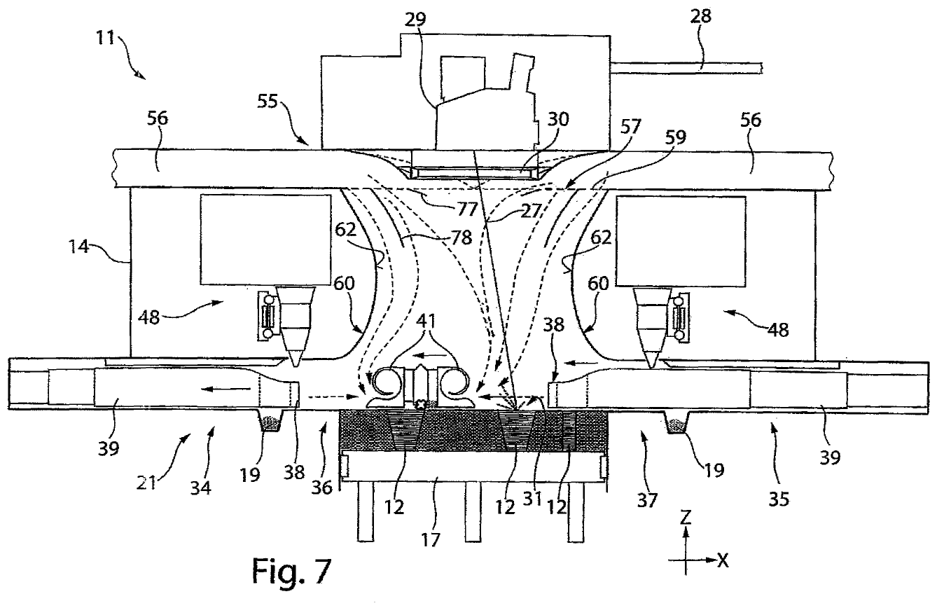

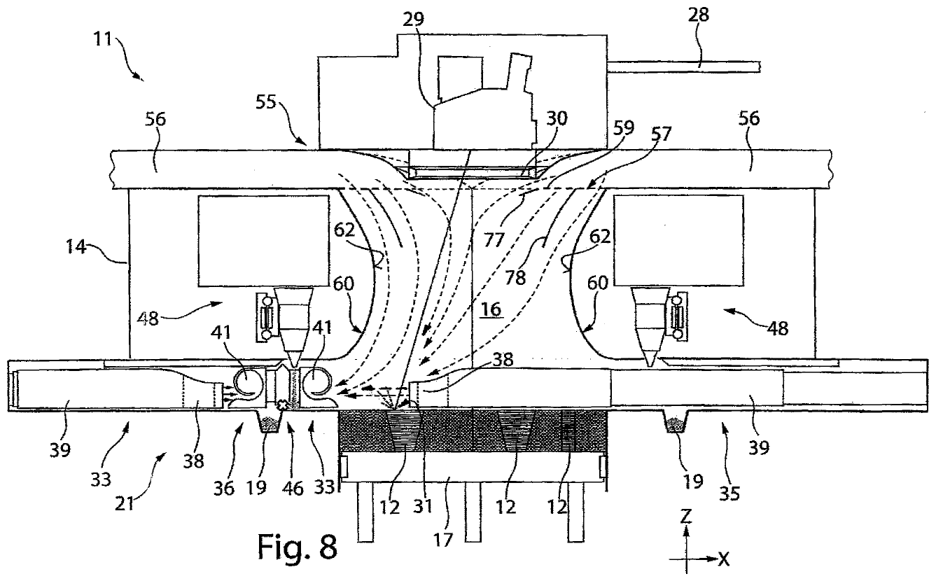

FIG. 7 illustrates a schematic side view of a working step of the apparatus 11 for producing the three-dimensional object 12 with an alternative embodiment of the process assistance device 21. FIG. 8 shows a further possible working position according to the embodiment of FIG. 7.

In this embodiment, it is provided that the process assistance device 21 has two outer modules 34, 35 triggered so as to be able to move. In this respect, the feed channels 56 preferably have a telescopic form, with the result that the outlet nozzles 38 can be moved relative to the build platform 17. The triggering of the outer modules 34, 35 to be able to move relative to the movement of the centre module 33 has the advantage that the section over which flow passes between the outlet nozzle 38 and the suction extracting device 41 can be kept short. This makes it possible to maintain the homogeneity of the primary gas stream along the section over which flow passes, as a result of which improved extraction by suction can be achieved. In the illustration of FIG. 7, it is provided that the centre module 33 is moved into an end position 36. In the process, the right outer module 35 follows the centre module 33, preferably at a constant distance. At the same time, the left outer module 34 is progressively transferred to the left end position 36. The simultaneous feed of the primary gas streams and the secondary gas stream makes it possible to achieve complete flushing of the process chamber 16. During the movement illustrated in FIG. 7, a primary gas stream is discharged preferably by both outer modules 34, 35 and extraction by suction of the primary gas stream and secondary gas stream by the two suction extracting devices 41 of the centre module 33 is triggered.

Also while the centre module 33 is being moved into an end position 36, 37 or into the end position 36, 37, such as the left end position 36, the primary gas stream and/or the secondary gas stream is maintained. Preferably, a constant flow of the entire process gas cycle is provided.

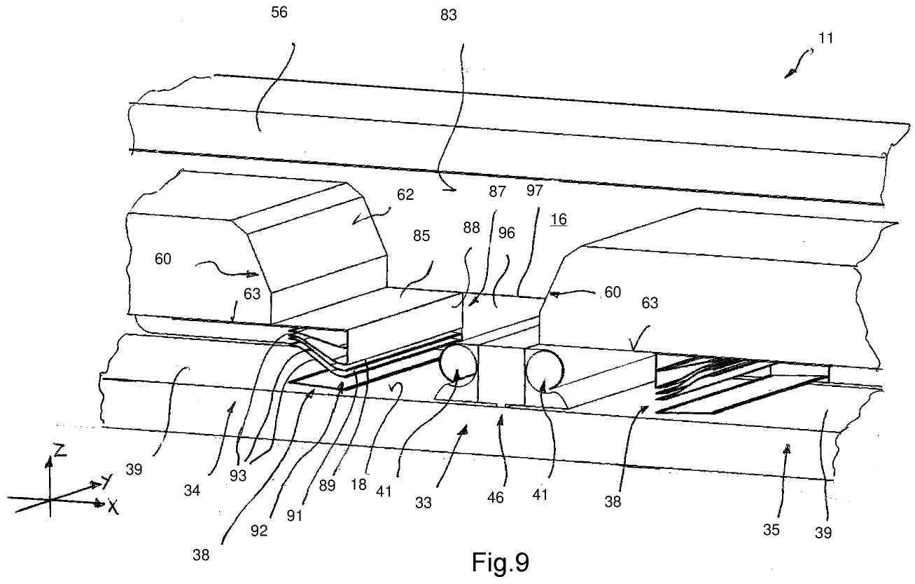

FIG. 9 shows a perspective view of a process chamber 16 of the apparatus 11 with an alternative embodiment of the outer modules 34, 35 in relation to the preceding figures. The outer modules 34, 35 preferably have the same form, and therefore only the outer module 34 is described below, wherein these statements likewise apply to the outer module 35.

The outer module 34 comprises an outlet nozzle 38, which extends transversely in relation to the movement direction along the build platform 17. The outlet nozzle 38 adjoins the two process chamber side walls 83 that laterally delimit the process chamber 16. Owing to the side view in FIG. 9, only one of the two process chamber side walls 83 is illustrated. An extensible cover 85 is provided above the outlet nozzle 38. This extensible cover 85 can be in the form of an extensible shroud, a roller shutter or the like. This cover 85 upwardly terminates a feed channel 39. Advantageously, the cover 85 likewise extends between the two process chamber side walls 83, with the result that lateral wall portions according to a first embodiment for forming a feed channel can be dispensed with. Preferably, it is provided that the feed channel 39 formed by the top cover 85 has a downwardly open form, that is to say that the feed channel does not have a wall portion in the direction of the build platform 17.

The outlet nozzle 38 has at least one subchannel 87 which on the outlet side has a filter laminate 88 or is closed by a filter laminate 88. This makes it possible to enable a diffuse flow for feeding the primary gas into the process chamber 16. Multiple subchannels 89, 91 and 92 are formed below the subchannel 87 that is closed with the filter laminate 88. The number of aforementioned subchannels is only exemplary. These subchannels 89, 91, 92 are formed by preferably horizontally aligned flow lamellae 93. These flow lamellae 93 extend preferably completely between the process chamber side walls 83. These flow lamellae 93 may be aligned in relation to one another by virtue of vertically aligned webs. Lateral wall portions for receiving the flow lamellae 93 may also be provided.

The flow lamellae 93 have an S-shaped form in the outlet direction of the primary gas stream from the feed channel 39 into the process chamber 16. Advantageously, the subchannel associated with the filter laminate 88 is formed with a smaller cross-sectional area and the subchannel 92 assigned directly to the process chamber floor 18 is formed with the largest cross-sectional area. This makes it possible to design the flow velocities exiting the subchannels 89, 91, 92 such that they increase towards the build platform 17. As an alternative, it is also possible for an outlet nozzle 38 to be formed with a lamellar structure of the flow lamellae 93, in the case of which outlet nozzle at least the top and the bottom subchannel 89, 92 generate a slower flow and at least one central subchannel 91 generates a higher or faster flow, with the result that a flow profile is formed in particular in accordance with a normal or Gaussian distribution (Gaussian curve).

In this embodiment, it is furthermore preferably provided for the at least one outlet nozzle 38 of the outer module 34 to be fixedly connected to a coupling element 96. By triggering a movement of the centre module 33 or of the outlet nozzle 38 of the outer module 34, it is possible for the outer module 34 or centre module 33, respectively, that is not driven or triggered so as to be movable to be forcibly carried along. The coupling element 96 advantageously closes an outlet opening 97 in the process chamber side wall 83, through which outlet opening processed process gas is discharged towards the outside.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for producing a three-dimensional object by selectively solidifying a build material applied layer by layer, the method comprising:
in at least one process chamber, applying the build material layer by layer to a build platform,
generating at least one beam for solidifying the build material using a radiation source, and feeding the at least one beam to the build material in the build platform using at least one beam guiding element,
generating a primary gas flow along the build platform using a process assistance device, wherein the process assistance device comprises a centre module and at least one outer module aligned with the centre module, so that a section over which primary gas flows is formed between the centre module and the at least one outer module,
wherein the centre module and/or the at least one outer module are triggered so as to be movable along the build platform.

2. The method according to claim 1, wherein the at least one outer module comprises two outer modules, the two outer modules are at a standstill in a respective end position outside the build platform, and the centre module is triggered to move over the build platform.

3. The method according to claim 1, wherein the centre module and the at least one outer module are triggered to move along the build platform, wherein a distance between the centre module and the at least one outer module is triggered to be constant or variable.

4. The method according to claim 1, wherein the at least one outer module discharges a primary gas flow towards the centre module, and a suction extracting device is provided on the centre module in alignment with the at least one outer module, and the primary gas flow is extracted by suction through an intake opening, aligned towards the outer module, of the suction extracting device.

5. The method according to claim 1, wherein a secondary gas flow is aligned onto and fed to the build platform using a feed device above the build platform, and a section along which the secondary gas flows is created between the feed device and the process assistance device.

6. The method according to claim 5, wherein, during a movement of the centre module above the build platform, two suction extracting devices of the centre module are triggered to extract the primary gas flow and the secondary gas flow by suction.

7. The method according to claim 5, wherein, in an event of a movement of the centre module into or out of an end position adjacent to the build platform or in an event of a positioning of the centre module in the end position, the primary gas flow and/or the secondary gas flow are/is maintained and the extraction by suction by at least one suction extracting device on the centre module is triggered.

8. The method according to claim 5, wherein, in an event of a movement of the centre module into or out of an end position adjacent to the build platform or in an event of a positioning of the centre module in the end position, only that suction extracting device of the centre module that faces the build platform is triggered to extract the primary gas flow and the secondary gas flow by suction, and/or only that outer module that is opposite and remote from the centre module is triggered to discharge the primary gas flow.

9. The method according to claim 3, wherein a magnitude of an exposure zone between the centre module and the outer module is controlled by the movement of the centre module and of the respective outer module.

10. An apparatus for producing three-dimensional objects by selectively solidifying a build material, applied layer by layer, by means of a beam acting on the build material, the apparatus comprising:
at least one process chamber comprising at least one build platform, wherein the at least one build platform is arranged in an X/Y plane and the three-dimensional object is created on the at least one build platform,
a radiation source for generating the beam,
at least one beam guiding element for guiding and directing the beam onto the build material to be solidified, wherein the beam is capable of being coupled into the process chamber through a beam inlet opening,
a process assistance device, wherein the process assistance device comprises a centre module and at least one outer module aligned with the centre module, for the purpose of generating a primary gas flow along the build platform, so that a section over which primary gas flows is formed between the at least one outer module and the centre module,
wherein the centre module and/or the at least one outer module are triggered so as to be movable along the build platform.

11. The apparatus according to claim 10, wherein the at least one outer module comprises two outer modules that are triggered to be at a standstill in a respective end position outside the build platform and the centre module is triggered to move over the build platform.

12. The apparatus according to claim 10, wherein the centre module and the at least one outer module are capable of being triggered to move along the build platform, wherein a distance between the centre module and the at least one outer module is triggered to be constant or variable.

13. The apparatus according to claim 10, wherein the centre module has at least one suction extracting device, the at least one suction extracting device comprises at least one rotary tube with a intake opening that faces the respective outer module and extends at least over a width of the build platform.

14. The apparatus according to claim 10, further comprising two layer-shaped storage containers for the build material and at least one coating device, arranged between two suction extracting devices of the centre module.

15. The apparatus according to claim 10, wherein the at least one outer module comprises an outlet nozzle.

16. The apparatus according to claim 10, wherein the at least one outer module is formed by a movable outlet nozzle that extends in an alignment transverse to a movement direction along the build platform and between process chamber side walls that laterally delimit the process chamber, and the at least one outer module has an extensible cover that adjoins the outlet nozzle, and is arranged above the build platform and extends in a width between the process chamber side walls that laterally delimit the process chamber.

17. The apparatus according to claim 16, wherein a feed channel for the primary gas flow intended to flow out of the outlet nozzle is formed at least by the extensible cover and the process chamber side walls or by the extensible cover with side wall portions that laterally adjoin it and extend as far as a process chamber floor.

18. The apparatus according to claim 16, wherein the centre module and the at least one outer module are connected fixedly to one another by a coupling element.

19. The apparatus according to claim 18, wherein the coupling element is capable of being moved along the process chamber side wall and is guided in an outlet opening in the process chamber side wall, through the outlet opening processed process gas is capable of being discharged from the process chamber.

20. The apparatus according to claim 18, wherein the coupling element is guided with a gap cover in the outlet opening.

21. The apparatus according to claim 16, wherein the outlet nozzle has flow lamellae, that form subchannels in the outlet opening of the outlet nozzle for a targeted flow.

22. The apparatus according to claim 21, wherein, in the outlet opening, the outlet nozzle has at least one subchannel that is closed by at least one filter laminate for forming a diffuse flow.

23. The apparatus according to claim 21, wherein the outlet nozzle of the outer module, in a top region, comprises at least the subchannel closed by the filter laminate and, in a bottom region, has multiple subchannels, of which the cross sections towards the build platform are formed to exhibit increasing flow velocities of the primary gas flow, or in that a flow profile is formed, so that a higher flow velocity is formed in a central region of the outlet nozzle than in the top region and the bottom region of the outlet nozzle.

24. The apparatus according to claim 10,
further comprising a feed device for feeding a secondary gas flow arranged above the build platform,
wherein the secondary gas flow is aligned onto the build platform by the feed device, and a section along which flow passes is formed between the feed device and the process assistance device.
